(19) United States
(12) Patent Application Publication
(10) Pub. No.: US 2022/0272220 A1
(43) Pub. Date: Aug. 25, 2022

(54) BOOTH

(71) Applicant: FUJIFILM BUSINESS INNOVATION CORP., Tokyo (JP)

(72) Inventors: Shu WATANABE, Kanagawa (JP); Ryuichi SHIRAISHI, Kanagawa (JP); Kengo TOKUCHI, Kanagawa (JP)

(73) Assignee: FUJIFILM BUSINESS INNOVATION CORP., Tokyo (JP)

(21) Appl. No.: 17/374,417

(22) Filed: Jul. 13, 2021

(30) Foreign Application Priority Data
Feb. 24, 2021 (JP) 2021-026919

(51) Int. Cl. H04N 1/00

(52) U.S. Cl. CPC H04N 1/00562; H04N 1/00543; H04N 1/00631; H04N 1/00408; H04N 1/00992; H04N 2201/0094

(57) ABSTRACT

A booth that is available for use when reserved and that is installed with an image forming apparatus accommodated therein, the booth including a panel having a first opening through which the image forming apparatus accommodated in the booth is operable by a person who has entered the booth; and a panel having a second opening through which the image forming apparatus accommodated in the booth is operable by a person from outside the booth.

### CROSS-REFERENCE TO RELATED APPLICATIONS

This application is based on and claims priority under 35 USC 119 from Japanese Patent Application No. 2021-026919 filed Feb. 24, 2021.

### BACKGROUND

### (i) Technical Field

The present disclosure relates to a booth in which a multifunction machine is installed.

### (ii) Related Art

A paper-sheet output mechanism provided in an outdoor stationary apparatus including a built-in printing device is known (see, for example, Japanese Unexamined Patent Application Publication No. 2020-59563). The paper-sheet output mechanism includes a paper-sheet delivery opening; a door that normally covers the paper-sheet delivery opening and opens when an external force is applied thereto; a paper-sheet passage that curls a paper sheet inward when the paper sheet is discharged from the printing device toward the paper-sheet delivery opening; and a guide shaped to extend vertically from the paper-sheet passage and then inward away from the paper-sheet delivery opening.

An automatic photographing apparatus that takes a photograph of a user is also known (Japanese Unexamined Patent Application Publication No. 2007-58006). The automatic photographing apparatus includes an imaging unit that takes an image of a user in a certain user space; a printing unit that prints the image taken by the imaging unit as a photograph and discharges the photograph to the outside of the user space; and a reception unit that is disposed outside the user space and receives a fee from the user before their photograph is taken. The reception unit is configured to be selectively installable at plural installation positions that are separated from the printing unit.

### SUMMARY

Aspects of non-limiting embodiments of the present disclosure relate to a booth that accommodates an image forming apparatus operable by a user from both inside and outside the booth.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a booth that is available for use when reserved and that is installed with an image forming apparatus accommodated therein, the booth including a panel having a first opening through which the image forming apparatus accommodated in the booth is operable by a person who has entered the booth; and a panel having a second opening through which the image forming apparatus accommodated in the booth is operable by a person from outside the booth.

### BRIEF DESCRIPTION OF THE DRAWINGS

Exemplary embodiments of the present disclosure will be described in detail based on the following figures, wherein:

FIG. 1 is a perspective view illustrating the internal structure of a booth according to an exemplary embodiment;

FIG. 2 is a perspective view illustrating the appearance of the booth according to the exemplary embodiment;

FIG. 3 illustrates an example of the manner in which the booth according to the exemplary embodiment is installed;

FIG. 4 is a perspective view illustrating the structure of an image forming apparatus accommodated in the booth;

FIG. 5 illustrates the manner in which the image forming apparatus is operated;

FIG. 6A illustrates a state in which the image forming apparatus is pulled out through a first opening;

FIG. 6B illustrates a state in which the image forming apparatus is pulled out through a second opening;

FIG. 7 is a schematic front view illustrating the location of the image forming apparatus in the booth;

FIG. 8 is a schematic plan view illustrating the arrangement of blind plates for reducing visibility of the image forming apparatus through the second opening;

FIGS. 9A and 9B are a schematic plan view and a schematic front view, respectively, illustrating the location of an air-conditioner outdoor unit and air discharged from the air-conditioner outdoor unit in the booth;

FIGS. 10A and 10B are a schematic plan view and a schematic front view, respectively, illustrating the location of the image forming apparatus in the booth;

FIG. 11A is a perspective view illustrating a state in which the image forming apparatus is operable through the first opening;

FIG. 11B is a perspective view illustrating a state in which the image forming apparatus is operable through the second opening;

FIG. 12 is a perspective view illustrating access to a paper tray;

FIGS. 13A and 13B are a schematic plan view and a schematic side view, respectively, illustrating the location of an image forming apparatus according to a modification in a booth;

FIGS. 14A and 14B are a schematic plan view and a schematic front view, respectively, illustrating the arrangement of image forming apparatuses in a booth according to a second exemplary embodiment;

FIG. 15 is a perspective view illustrating access to an image forming apparatus from inside the booth;

FIG. 16 is a perspective view illustrating access to an image forming apparatus from outside the booth;

FIGS. 17A and 17B are a schematic plan view and a schematic front view, respectively, illustrating the location of an image forming apparatus in a booth according to a third exemplary embodiment;

FIG. 18 illustrates the manner in which a printed paper sheet is taken out from the image forming apparatus in the booth according to the third exemplary embodiment; and

FIG. 19 is a schematic diagram illustrating an example of the overall configuration of a system for reserving a booth.

### DETAILED DESCRIPTION

The present disclosure will be described in further detail by way of exemplary embodiments and examples with reference to the drawings. However, the present disclosure is not limited to the exemplary embodiments and examples.

It is to be noted that the drawings referred to in the following description are schematic, and that dimensional ratios, for example, in the drawings differ from the actual ones. Components other than those necessary to be described to facilitate understanding are omitted as appropriate in the drawings.

### First Exemplary Embodiment

### (1) Overall Structure of Booth

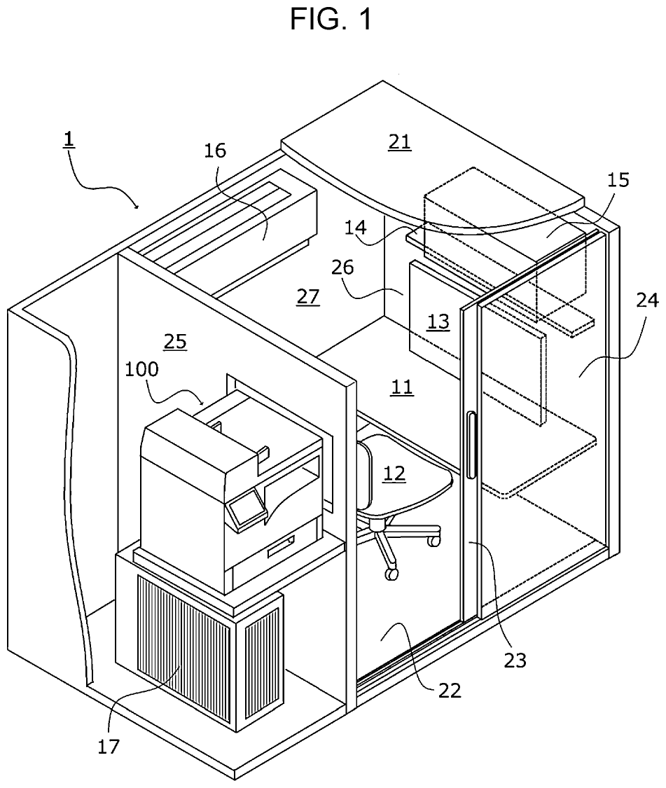

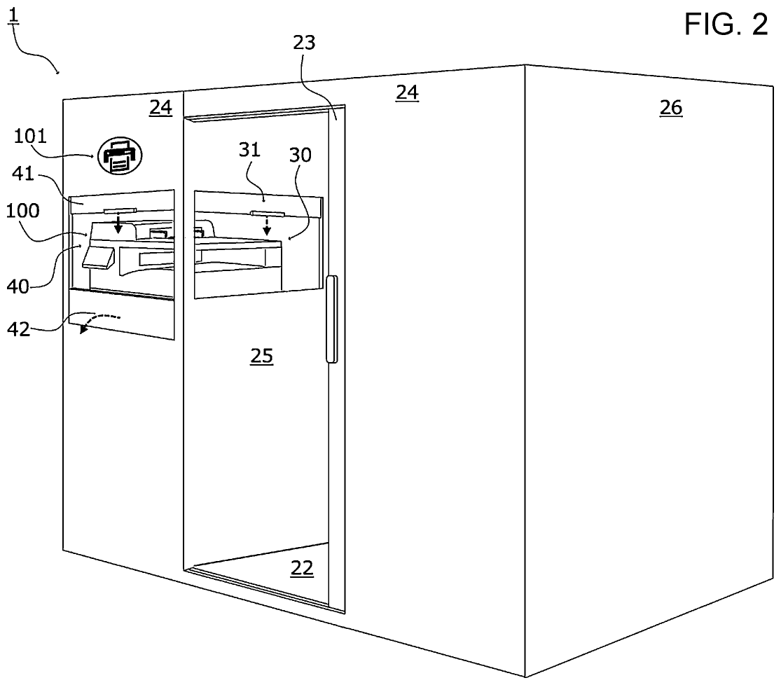

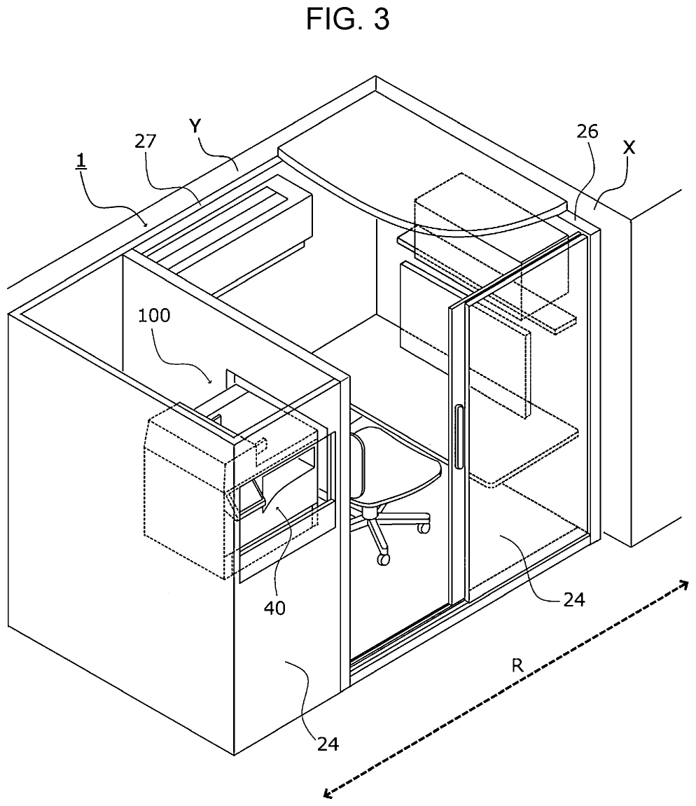

FIG. 1 is a perspective view illustrating the internal structure of a booth 1 according to a first exemplary embodiment. FIG. 2 is a perspective view illustrating the appearance of the booth 1 according to the present exemplary embodiment. FIG. 3 illustrates an example of the manner in which the booth 1 according to the present exemplary embodiment is installed. The overall structure of the booth 1 will now be described with reference to the drawings.

As illustrated in FIG. 1, the booth 1 is box-shaped in overall configuration and accommodates a desk 11, a chair 12, a monitor 13, a light 14, an electric component box 15, an air-conditioner indoor unit 16, an air-conditioner outdoor unit 17, and an image forming apparatus 100. A user may sit on the chair 12 in an air-conditioned space S1 provided in the booth 1 and perform various tasks, such as work or studying, on the desk 11 using the monitor 13. On-line services may also be available through an electric communication line. The image forming apparatus 100 accommodated in the booth 1 is accessible from inside and outside the booth 1 to receive services, such as printing, copying, or scanning, under certain conditions.

A framework of the booth 1 includes a ceiling panel 21; a floor 22; a front wall panel 24 to which a door 23 is attached, the door 23 covering and uncovering an opening S through which the user enters and leaves; a left wall panel 25 and a right wall panel 26 located on both sides of the front wall panel 24; and a back wall panel 27 disposed to face the door 23.

In the present exemplary embodiment, the door 23 is a sliding door. An electronic lock (not illustrated) that may be unlocked with an electronic key is attached to the door 23 to enable services such as rental.

As illustrated in FIG. 2, an inner surface of the left wall panel 25 of the booth 1 has a first opening 30 that enables operation of the image forming apparatus 100 from inside the booth 1. The front wall panel 24 has a second opening 40 that enables operation of the image forming apparatus 100 from outside the booth 1.

A first door 31 is attached to the first opening 30. The first door 31 is movable between an open position at which the first door 31 uncovers the first opening 30 and a closed position at which the first door 31 covers the first opening 30 (see the arrow in FIG. 2).

A second door 41 is attached to the second opening 40. The second door 41 is movable between an open position at which the second door 41 uncovers the second opening 40 and a closed position at which the second door 41 covers the second opening 40 (see the arrow in FIG. 2).

A third door 42 is also attached to the second opening 40 such that the third door 42 may be opened and closed (see the arrow in FIG. 2). The third door 42 enables access to a paper tray 120, which serves as a paper storage unit of the image forming apparatus 100.

As illustrated in FIG. 2, a guide display 101 that indicates the presence of the image forming apparatus 100 is provided on the front wall panel 24 above the second opening 40. The guide display 101 is an icon representing an image forming apparatus, such as a printer. The guide display 101 may be a sticker on which the icon is printed, or be directly printed on the front wall panel 24. The guide display 101 is not limited to an icon, and may instead be, for example, a text, an image, or a two-dimensional pattern. When the guide display 101 is provided in a region around the location in front of the second opening 40 as described above, a person who intend to access the image forming apparatus 100 accommodated in the booth 1 from outside the booth 1 may be informed of the presence of the image forming apparatus 100.

The booth 1 having the above-described structure may be assembled in a factory or the like, transported on a cargo platform of a truck or the like, and installed at a certain installation site. The installation site may be an external space accessible by both passersby and users of the booth 1. Examples of the external space include an internal corner space or a space in front of a wall surface of a building framework. The installation site is not limited to an internal corner space or a space in front of a wall surface of a building framework, and may be any external space such as a concourse, a passageway of an office building, a trade fair site, a commercial space, or a convenience store.

More specifically, as illustrated in FIG. 3, the booth 1 may be installed at an internal corner space defined by two wall surfaces, which are a first wall surface X and a second wall surface Y, such that the right wall panel 26 faces the first wall surface X of the internal corner space and the back wall panel 27 faces the second wall surface Y of the internal corner space. The booth 1 installed in this manner does not excessively project into a passageway or obstruct passage of people (shown by arrow R in FIG. 3) when the image forming apparatus 100 accommodated in the booth 1 is operated from outside the booth 1 through the second opening 40 in the front wall panel 24.

### (2) Location and Operation of Image Forming Apparatus

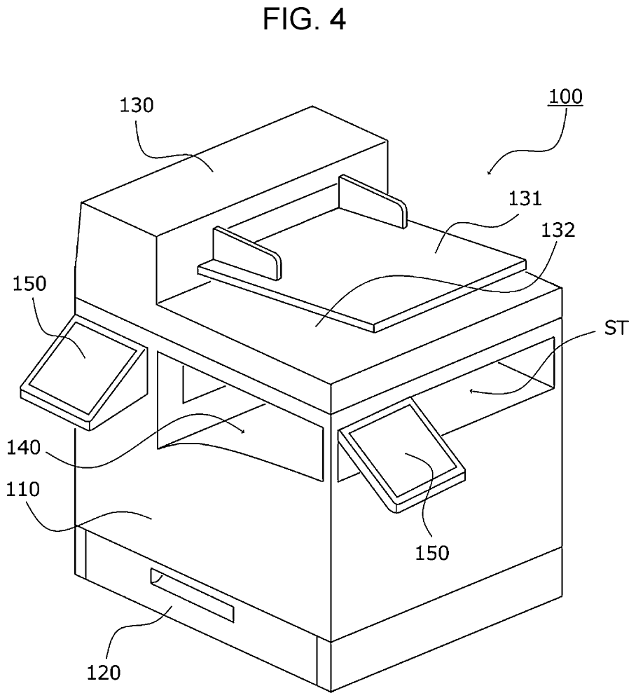

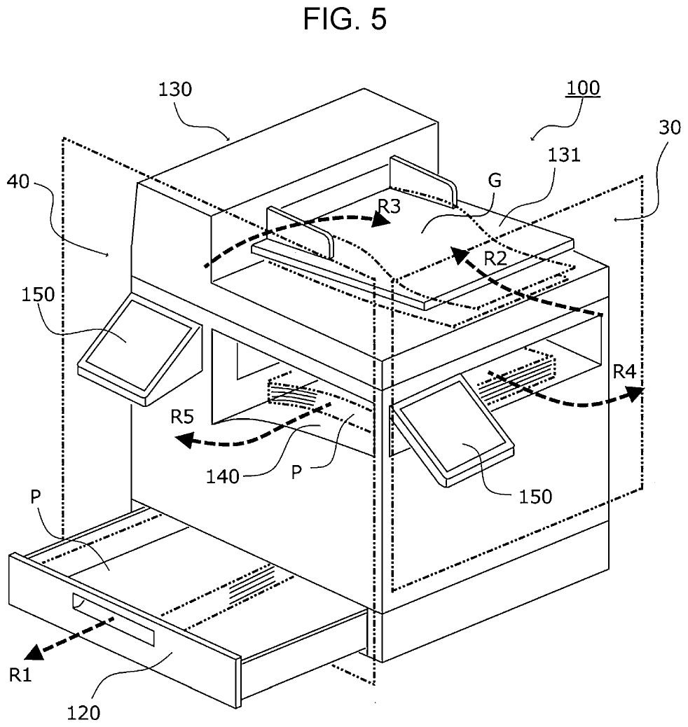

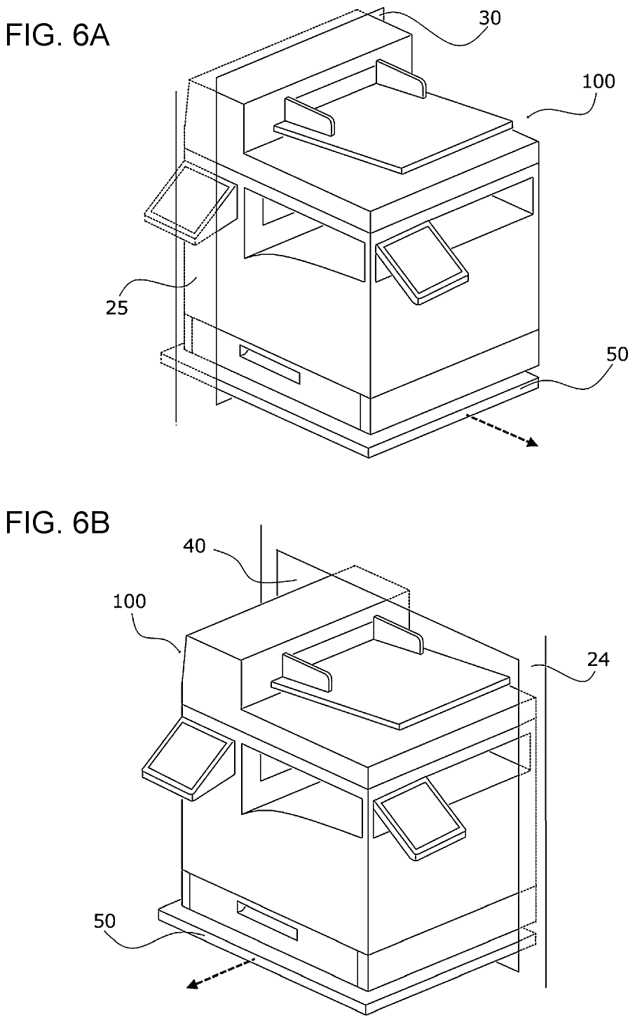

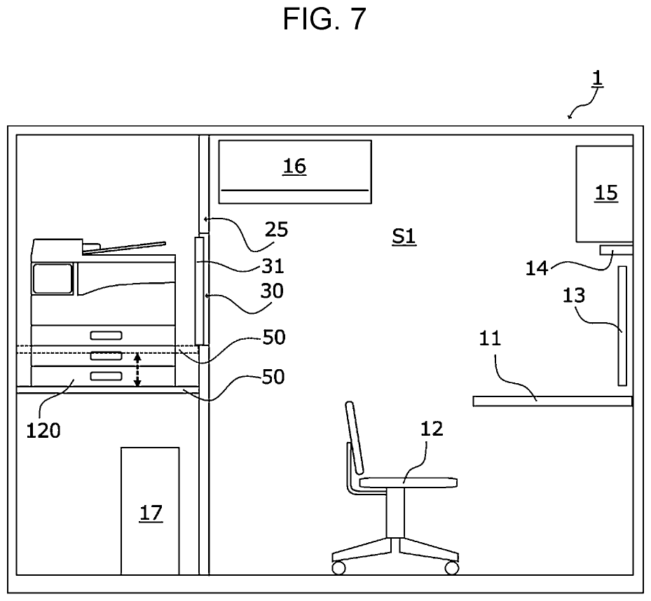

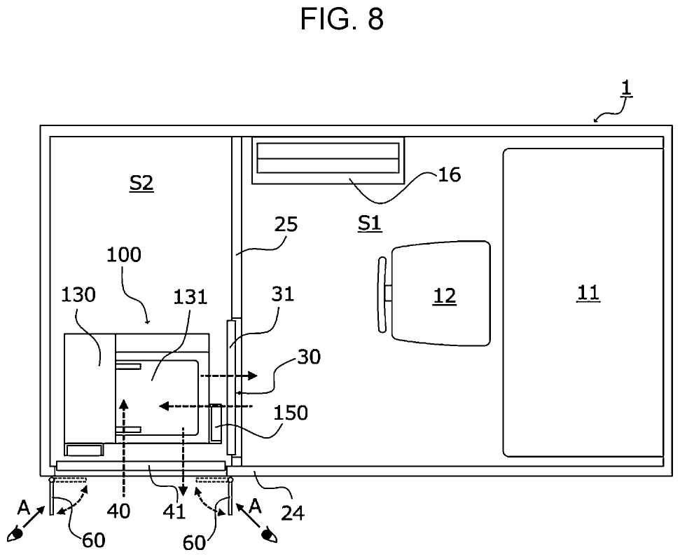

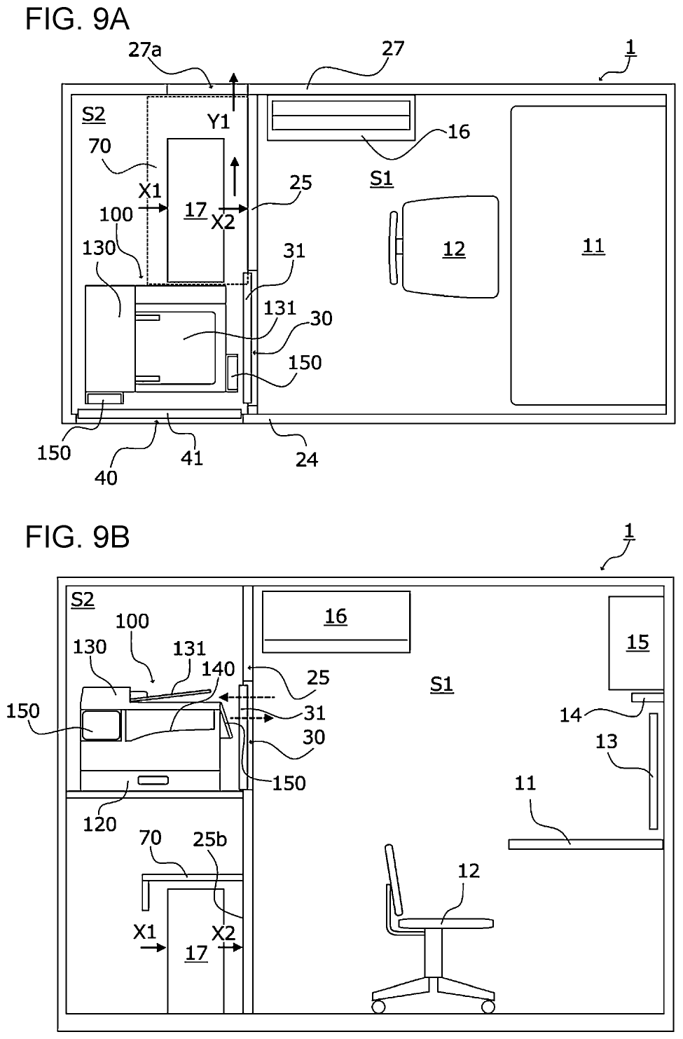

FIG. 4 is a perspective view illustrating the structure of the image forming apparatus 100 accommodated in the booth 1. FIG. 5 illustrates the manner in which the image forming apparatus 100 is operated. FIG. 6A illustrates a state in which the image forming apparatus 100 is pulled out through the first opening 30. FIG. 6B illustrates a state in which the image forming apparatus 100 is pulled out through the second opening 40. FIG. 7 is a schematic front view illustrating the location of the image forming apparatus 100 in the booth 1. FIG. 8 is a schematic plan view illustrating the arrangement of blind plates 60 for reducing visibility of the image forming apparatus 100 through the second opening 40. FIGS. 9A and 9B are a schematic plan view and a schematic front view, respectively, illustrating the location of the air-conditioner outdoor unit 17 and air discharged from the air-conditioner outdoor unit 17 in the booth 1. The location and operation of the image forming apparatus 100 accommodated in the booth 1 will now be described with reference to the drawings.

### (2.1) Structure of Image Forming Apparatus

The image forming apparatus 100 includes a paper tray 120, which is an example of a paper storage unit, below an image forming unit 110 that forms an image on a paper sheet. The paper tray 120 stores paper sheets P, and is provided with a paper guide (not illustrated) adjustable in accordance with the size of the paper sheets P. The paper sheets P stored in the paper tray 120 are separated from each other and fed one at a time to the image forming unit 110 by a feeding device (not illustrated). Although FIG. 4 illustrates one paper tray 120, plural paper trays 120 may be provided.

The image forming apparatus 100 is disposed with the paper tray 120 thereof facing the front wall panel 24, so that the paper tray 120 is accessible through the second opening 40. As illustrated in FIG. 5, the paper tray 120 may be pulled out through the second opening 40 (see arrow R1 in FIG. 5) to enable supply of the paper sheets P. Thus, the paper sheets P may be supplied to the image forming apparatus 100 accommodated in the booth 1 from outside the booth 1.

An image reading device 130 is disposed above the image forming unit 110. The image reading device 130 transports a document G placed on a document table 131 to an image reading unit (not illustrated). The image reading unit reads an image of the document G and converts the read image into image data, which is an electric signal. After the image of the document G is read by the image reading unit, the document G is output to a document output unit 132.

Referring to FIG. 5, the image reading device 130 executes an image reading operation when a user who has entered the booth 1 inserts the document G onto the document table 131 through the first opening 30 (see arrow R2 in FIG. 5). The image reading operation is also executed when a user outside the booth 1 places the document G onto the document table 131 through the second opening 40 (see arrow R3 in FIG. 5).

A paper output tray 140 is provided in an internal space ST that is above the image forming unit 110 and below the image reading device 130. The paper sheets P on which images have been formed by the image forming unit 110 are output and stacked on the paper output tray 140.

As illustrated in FIG. 5, the user who has entered the booth 1 may access the paper output tray 140 through the first opening 30 to take out the paper sheets P output onto the paper output tray 140 (see arrow R4 in FIG. 5). The user outside the booth 1 may take out the paper sheets P output onto the paper output tray 140 through the second opening 40 (see arrow R5 in FIG. 5).

An operation display unit 150 that serves as a user interface is disposed on a front surface of the image forming apparatus 100. The operation display unit 150 includes a combination of, for example, a liquid crystal display panel, various operation buttons, and a touch panel. The user of the image forming apparatus 100 inputs various settings and instructions through the operation display unit 150, and the liquid crystal display panel displays various information to the user of the image forming apparatus 100. The operation display unit 150 is also provided with a touch unit for near field communication (NFC) that enables near field wireless communication with a device operated by the user.

In the present exemplary embodiment, another operation display unit 150 is disposed on a side surface of the image forming apparatus 100 that is at an angle of 90 degrees relative to the front surface. Referring to FIG. 5, the user who has entered the booth 1 accesses the operation display unit 150 on the side surface through the first opening 30 to operate and check the display of the operation display unit 150. The user outside the booth 1 accesses the operation display unit 150 on the front surface through the second opening 40.

The image forming apparatus 100 according to the present exemplary embodiment is placed on an installation table 50. The installation table 50 is supported such that the installation table 50 is horizontally movable relative to the left wall panel 25 and the front wall panel 24 along slide rails (not illustrated).

As illustrated in FIG. 6A, the first door 31 may be opened and the image forming apparatus 100 may be pulled out into an inner space in the booth 1 through the first opening 30 (see the arrow in FIG. 6A) to enable maintenance including replenishment of ink, such as toner, and recovery from an error, such as paper jam. Similarly, as illustrated in FIG. 6B, the second door 41 may be opened and the image forming apparatus 100 may be pulled out of the booth 1 through the second opening 40 (see the arrow in FIG. 6B) to enable maintenance.

The position of the installation table 50 in the vertical direction is adjustable. As illustrated in FIG. 7, when the image forming apparatus 100 includes plural paper trays 120 (three paper trays 120 in FIG. 7), the installation table 50 may be moved in the vertical position (see the arrow in FIG. 7) so that the paper output position is constant.

As illustrated in FIG. 8, the booth 1 according to the present exemplary embodiment includes the blind plates 60 provided on the front wall panel 24 to reduce visibility of the image forming apparatus 100 in the booth 1 through the second opening 40 from locations other than the front of the second opening 40. The blind plates 60 are foldable relative to the front wall panel 24. When the blind plates 60 are unfolded outward, the image forming apparatus 100 is not easily visible from locations other than the front, as shown by arrows A in FIG. 8. The presence of the image forming apparatus 100 is recognizable to those who intend to use the image forming apparatus 100 from outside the booth 1 because, as described above, the guide display 101 that indicates the presence of the image forming apparatus 100 is provided on the front wall panel 24 above the second opening 40 (see FIG. 2).

In the booth 1 according to the present exemplary embodiment, the image forming apparatus 100 is disposed above the air-conditioner outdoor unit 17. As illustrated in FIGS. 9A and 9B, the air-conditioner outdoor unit 17 is covered with a covering member 70 so that air sucked into the air-conditioner outdoor unit 17 (see arrow X1 in FIGS. 9A and 9B), air discharged from the air-conditioner outdoor unit 17 (see arrow X2 in FIGS. 9A and 9B), and water vapor do not flow toward the image forming apparatus 100.

As illustrated in FIG. 9A, the air-conditioner outdoor unit 17 is disposed so that air discharged therefrom (see arrow X2 in FIGS. 9A and 9B) is directed toward an outer surface 25b of the left wall panel 25, flows along the outer surface 25b of the left wall panel 25 together with water vapor generated from drain water, and is discharged to the outside through an air outlet 27a formed in the back wall panel 27 (see arrow Yl in FIG. 9A). Accordingly, the air flow generated by the air-conditioner outdoor unit 17 does not affect the image forming apparatus 100.

### (2.2) Location of Image Forming Apparatus

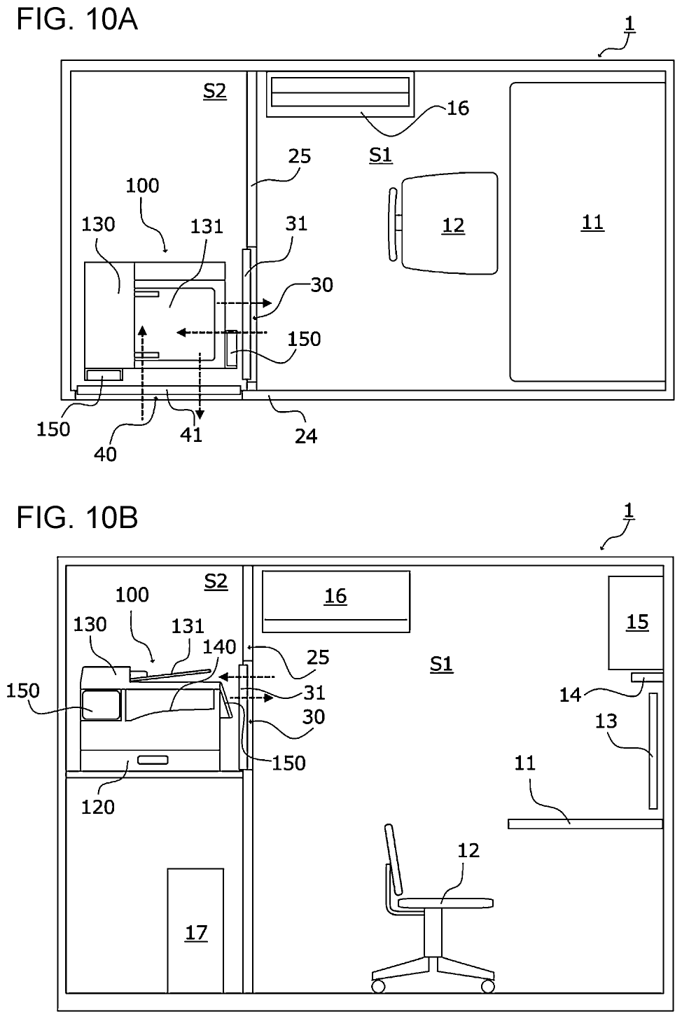

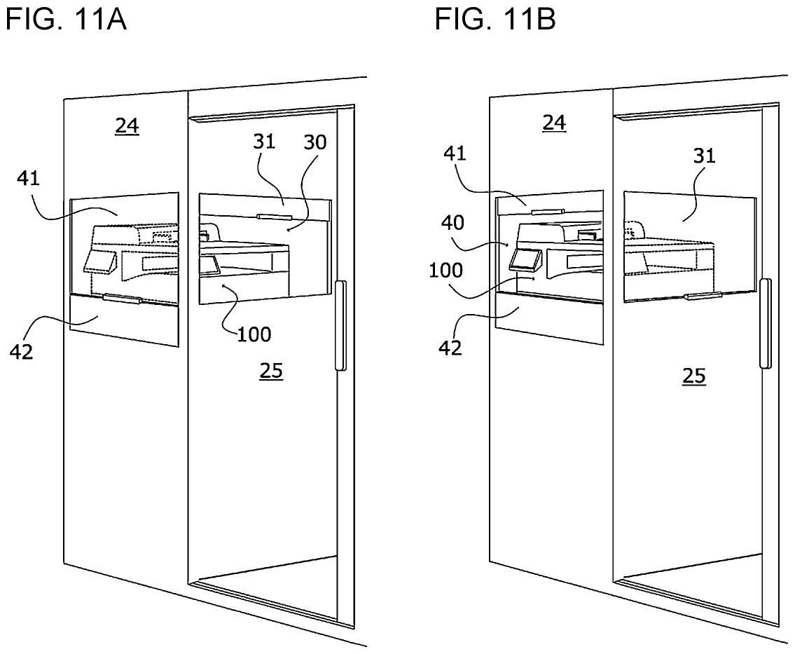

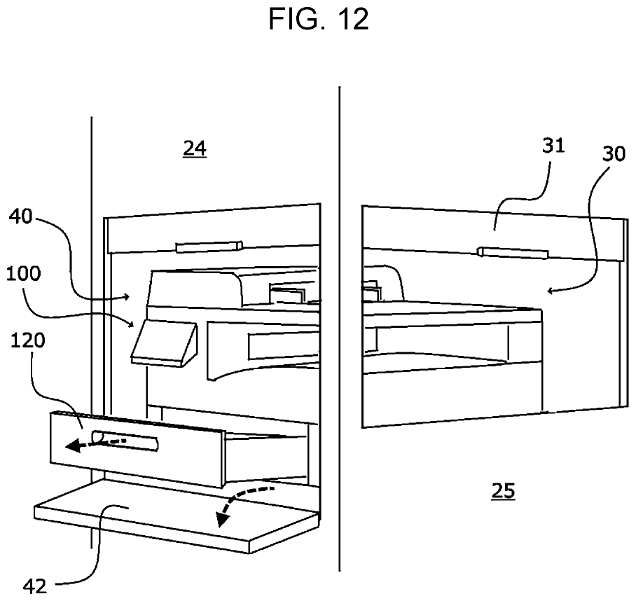

FIGS. 10A and 10B are a schematic plan view and a schematic front view, respectively, illustrating the location of the image forming apparatus 100 in the booth 1. FIG. 11A is a perspective view illustrating a state in which the image forming apparatus 100 is operable through the first opening 30. FIG. 11B is a perspective view illustrating a state in which the image forming apparatus 100 is operable through the second opening 40. FIG. 12 is a perspective view illustrating access to the paper tray 120. The location and operation of the image forming apparatus 100 in the booth 1 will now be described with reference to the drawings.

As illustrated in FIGS. 10A and 10B, the image forming apparatus 100 is disposed in a space S2 that is adjacent to the air-conditioned space S1 with the left wall panel 25 provided therebetween, the air-conditioned space S1 accommodating the desk 11, the chair 12, and the air-conditioner indoor unit 16.

As illustrated in FIG. 10A, the image forming apparatus 100 is located to be accessible and operable through the first opening 30 in the left wall panel 25 from inside the booth 1, and accessible and operable through the second opening 40 in the front wall panel 24 from outside the booth 1.

In the present exemplary embodiment, the first door 31 and the second door 41 are moved to the open positions thereof so that the first opening 30 and the second opening 40 are uncovered to enable operation of the image forming apparatus 100 therethrough (see the arrows in FIGS. 10A and 10B).

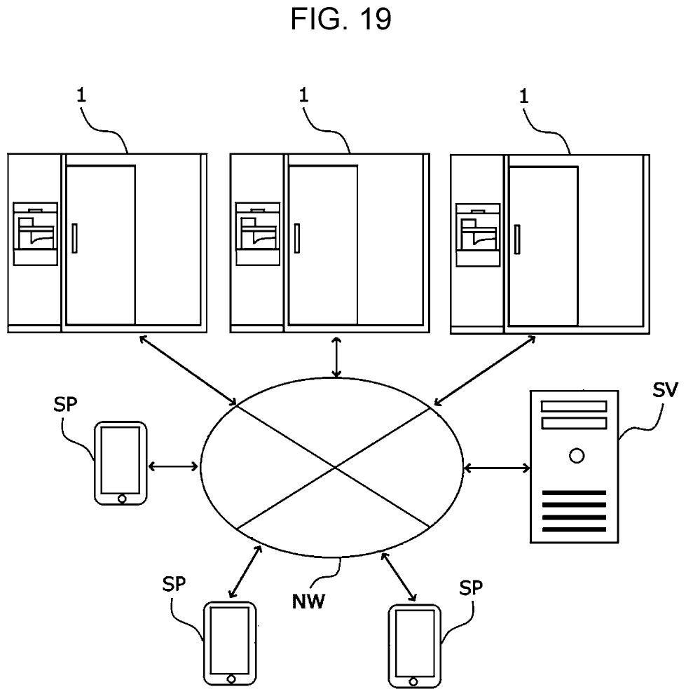

FIG. 19 is a schematic diagram illustrating an example of the overall configuration of a system for reserving a booth 1.

In the present exemplary embodiment, an electronic key composed of a key opening signal is used to lock and unlock the first door 31 or the second door 41 of each booth 1, and the electronic key is stored in a portable subscriber terminal SP. The portable subscriber terminal SP is assumed to be a smartphone, but may instead be a so-called wearable or bearable terminal or a game terminal having a function of communicating with the Internet.

When the subscriber terminal SP is used as an electronic key, the electronic key is transmitted to the subscriber terminal SP from a reservation management server SV after a reservation is made. The user operates the subscriber terminal SP that has received the electronic key or places the subscriber terminal SP in a certain position to unlock the first door 31 or the second door 41. Alternatively, the subscriber terminal SP may be used to read a two-dimensional code pattern displayed on the booth 1 and unlock the first door 31 or the second door 41 with the electronic key stored therein. An authentication of the subscriber, that is, the user, may be used instead of or as a supplement to the electronic key. Thus, unauthorized usage of the image forming apparatus 100 may be prevented.

FIG. 11A illustrates the first opening 30 and the second opening 40 in the case where the image forming apparatus 100 is accessed and operated from inside the booth 1. As illustrated in FIG. 11A, the first door 31 is moved to the open position thereof to uncover the first opening 30 and enable operation of the image forming apparatus 100.

Assuming that a user has reserved the use of the image forming apparatus 100 upon reservation for the use of the booth 1, the movement of the first door 31 is enabled when the user operates the subscriber terminal SP with which the booth 1 has been reserved, places the subscriber terminal SP in a certain position, or reads the two-dimensional code pattern, which is an example of a code displayed on the booth 1. While the first opening 30 is uncovered and the image forming apparatus 100 is operated by the user from inside the booth 1, the second door 41 is not opened, so that the image forming apparatus 100 is not operable from outside the booth 1, as illustrated in FIG. 11A.

FIG. 11B illustrates the first opening 30 and the second opening 40 in the case where the image forming apparatus 100 is accessed and operated from outside the booth 1. As illustrated in FIG. 11B, the second door 41 is moved to the open position thereof to uncover the second opening 40 and enable operation of the image forming apparatus 100.

Assuming that a user has reserved the use of the image forming apparatus 100, the second door 41 is unlocked and the movement thereof is enabled when the user operates the subscriber terminal SP with which the image forming apparatus 100 has been reserved. While the second opening 40 is uncovered and the image forming apparatus 100 is operated by the user from outside the booth 1, the first door 31 is not opened, so that the image forming apparatus 100 is not operable from inside the booth 1, as illustrated in FIG. 11B.

The third door 42 may be opened to enable access to the paper tray 120 of the image forming apparatus 100 from outside the booth 1 through the second opening 40. More specifically, as illustrated in FIG. 12, the third door 42 may be pivoted forward (see the arrow in FIG. 12) to enable operation of the paper tray 120 from outside the booth 1. The paper tray 120 may be pulled forward (see the arrow in FIG. 12) so that the paper sheets P may be supplied thereto.

According to the booth 1 having the above-described structure, when no paper sheets P are supplied to the paper tray 120 and when a print job that has been started is not completed due to lack of paper, no fee is charged, and designated print job data is transferred to an image forming apparatus in another booth. The operation display units 150 on the image forming apparatus 100 that has run out of paper display the location of the other booth to which the data has been transferred.

### Modification

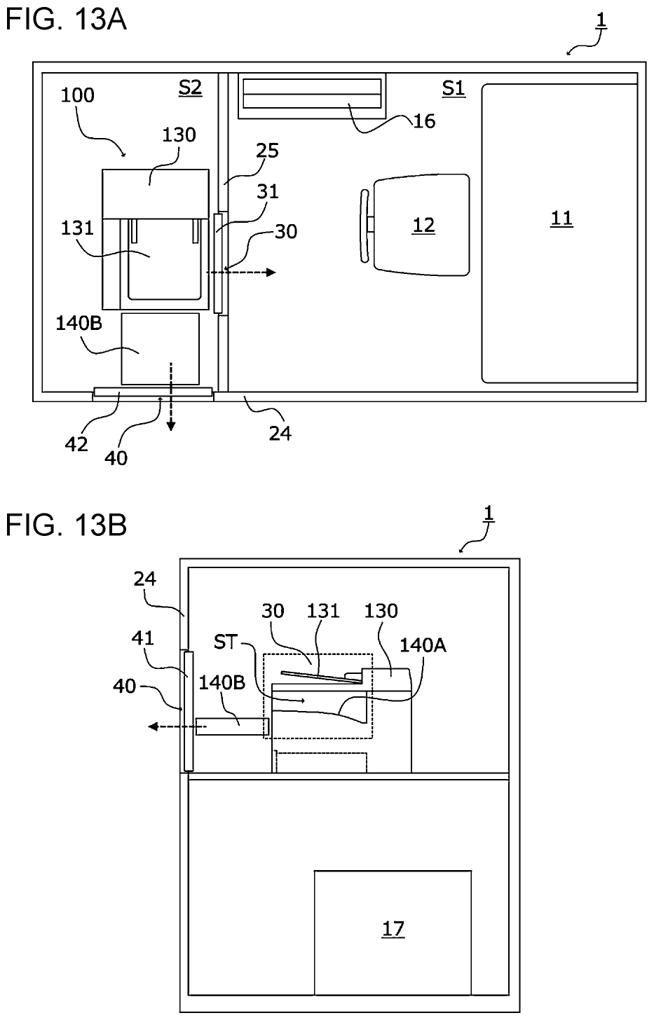

FIGS. 13A and 13B are a schematic plan view and a schematic side view, respectively, illustrating the location of an image forming apparatus 100 according to a modification in the booth 1.

The image forming apparatus 100 according to the modification includes a first paper output tray 140A from which a printed paper sheet P is taken out in a direction toward the first opening 30 and a second paper output tray 140B from which a printed paper sheet P on is taken out in a direction toward the second opening 40.

The first paper output tray 140A is an output-paper receiving unit formed in the internal space ST that is above the image forming unit 110 and below the image reading device 130. The user in the booth 1 opens the first door 31 that covers the first opening 30 and accesses the first paper output tray 140A (see the arrow in FIG. 13A) to take out the printed paper sheet P.

The second paper output tray 140B is disposed in front of the first paper output tray 140A in a paper output direction. The paper sheet P on which an image has been formed by the image forming unit 110 passes the first paper output tray 140A, and is placed on the second paper output tray 140B. The user outside the booth 1 opens the second door 41 that covers the second opening 40 and accesses the second paper output tray 140B (see the arrows in FIGS. 13A and 13B) to take out the printed paper sheet P.

The user operates the subscriber terminal SP to unlock the first door 31 or the second door 41, and uncovers the first opening 30 or the second opening 40 to enable access to the first paper output tray 140A or the second paper output tray 140B.

According to the booth 1 having the above-described structure, the image forming apparatus 100 accommodated in the booth 1 may be used from both inside and outside the booth 1. The image forming apparatus 100 is not accessible from inside the booth 1 while the image forming apparatus 100 is being used from outside the booth 1, and is not accessible from outside the booth 1 while the image forming apparatus 100 is being used from inside the booth 1.

### Second Exemplary Embodiment

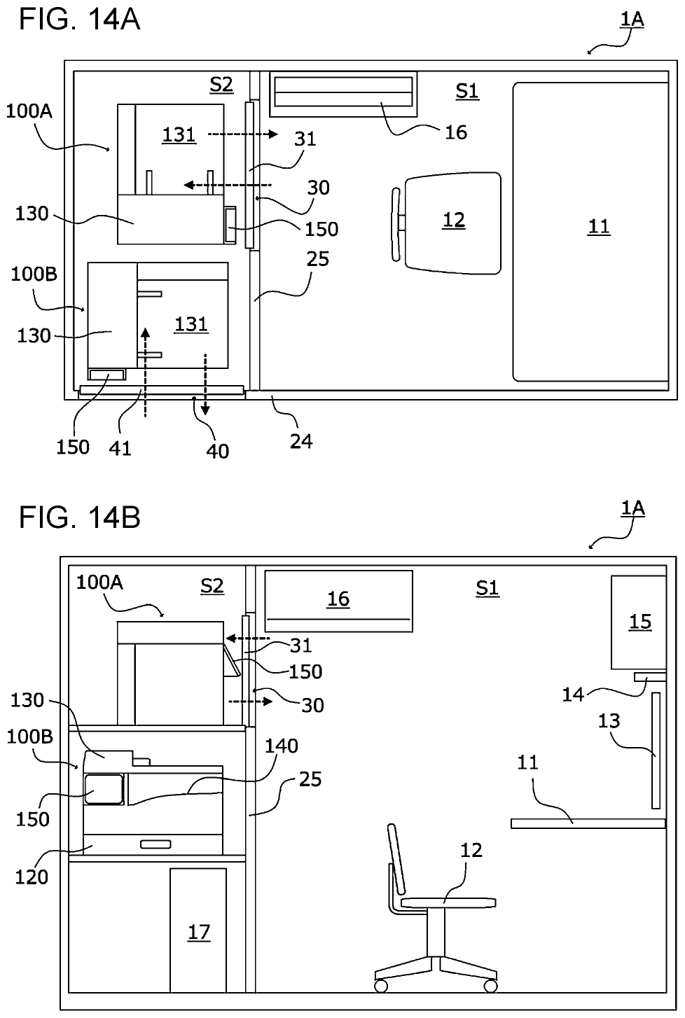

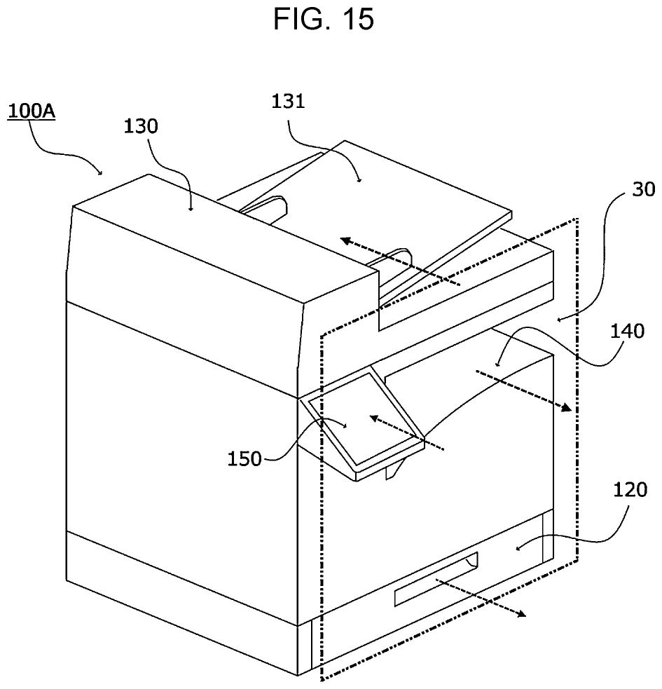

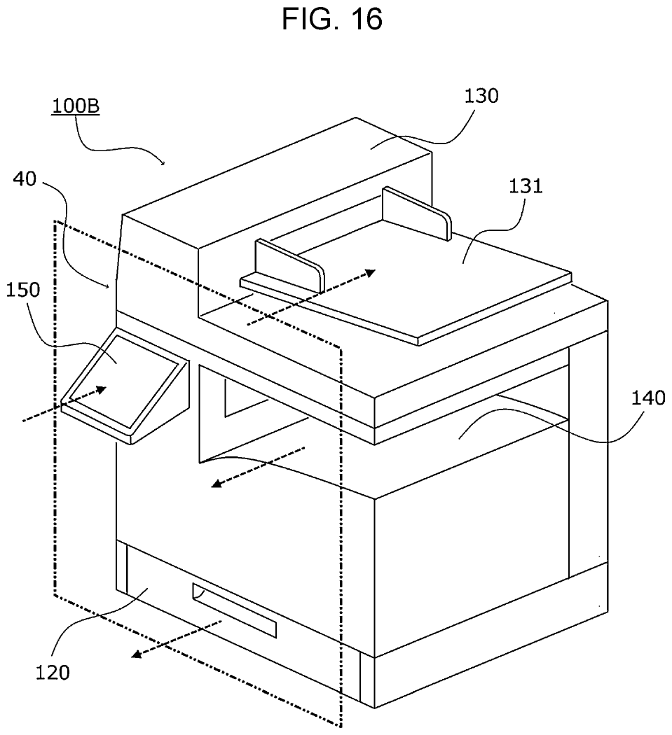

FIGS. 14A and 14B are a schematic plan view and a schematic front view, respectively, illustrating the arrangement of image forming apparatuses in a booth 1A according to a second exemplary embodiment. FIG. 15 is a perspective view illustrating access to an image forming apparatus from inside the booth 1A. FIG. 16 is a perspective view illustrating access to an image forming apparatus from outside the booth 1A.

The booth 1A according to the present exemplary embodiment differs from the booth 1 according to the first exemplary embodiment in that the booth 1A accommodates a first image forming apparatus 100A, which is accessible in a direction from the first opening 30, and a second image forming apparatus 100B, which is accessible in a direction from the second opening 40. Components that are the same as those in the booth 1 according to the first exemplary embodiment are denoted by the same reference signs, and detailed description thereof is omitted.

As illustrated in FIGS. 14A and 14B, the first image forming apparatus 100A and the second image forming apparatus 100B have the same structure, and each include an image forming unit 110, a paper tray 120, an image reading device 130, a paper output tray 140, and an operation display unit 150. The first image forming apparatus 100A and the second image forming apparatus 100B are respectively accessible through the first opening 30 and the second opening 40 (see the arrows in FIGS. 14A and 14B).

As schematically illustrated in FIG. 15, the first image forming apparatus 100A is disposed so that the paper tray 120, the image reading device 130, the paper output tray 140, and the operation display unit 150 thereof face the first opening 30 in the left wall panel 25.

The user in the booth 1A operates the subscriber terminal SP with which the use of the booth 1A has been reserved, places the subscriber terminal SP in a certain position, or reads a two-dimensional code pattern, which is an example of a code displayed on the booth 1A. Accordingly, the first door 31 is moved to an open position to uncover the first opening 30 to enable operation of the first image forming apparatus 100A (see the arrows in FIG. 15).

As schematically illustrated in FIG. 16, the second image forming apparatus 100B is disposed so that the paper tray 120, the image reading device 130, the paper output tray 140, and the operation display unit 150 thereof face the second opening 40 in the front wall panel 24.

The user outside the booth 1A operates the subscriber terminal SP with which the use of the second image forming apparatus 100B has been reserved to unlock the second door 41 and enable operation of the second image forming apparatus 100B (see the arrows in FIG. 16).

### Third Exemplary Embodiment

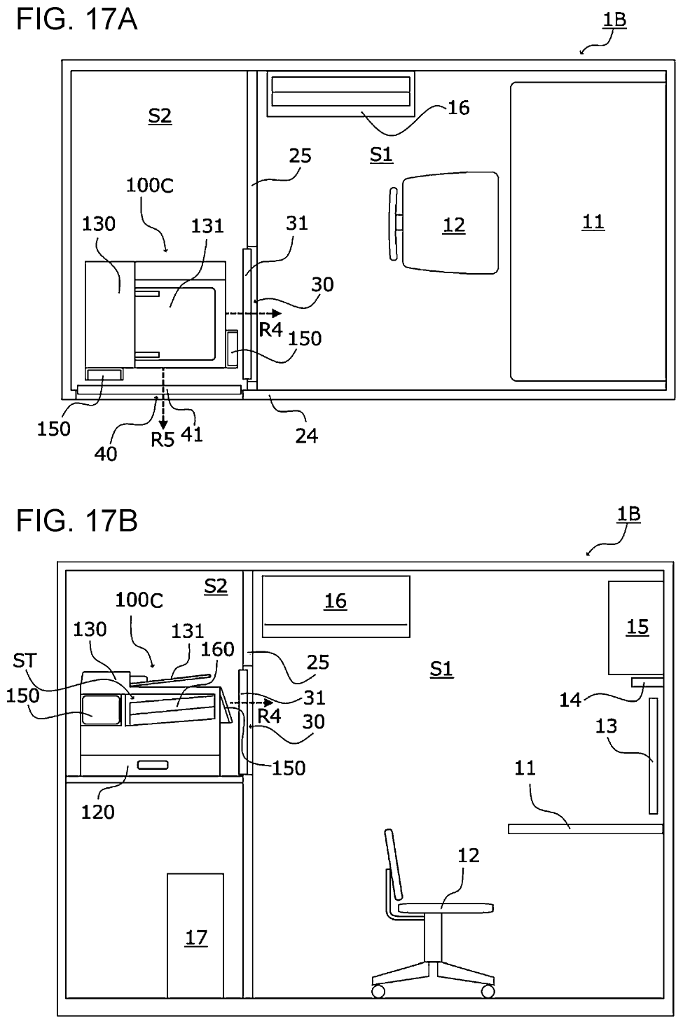

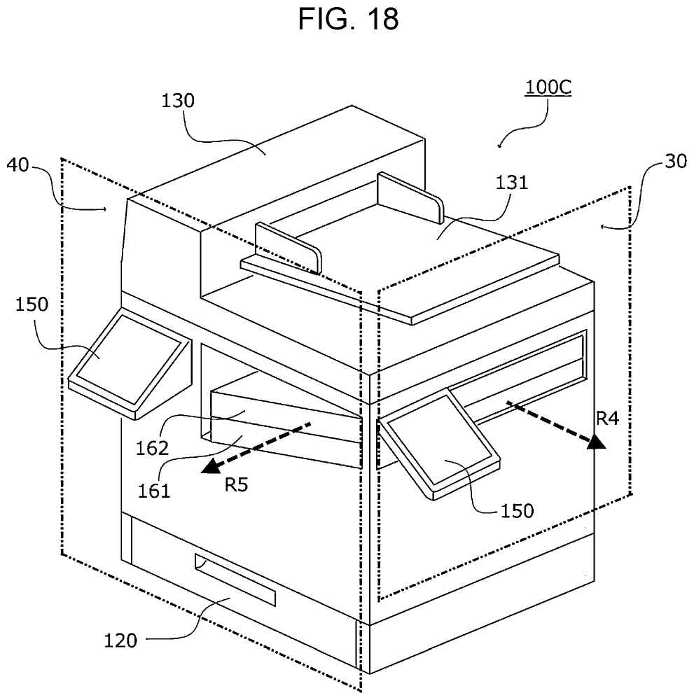

FIGS. 17A and 17B are a schematic plan view and a schematic front view, respectively, illustrating the location of an image forming apparatus 100C in a booth 1B according to a third exemplary embodiment. FIG. 18 illustrates the manner in which a printed paper sheet P is taken out from the image forming apparatus 100C.

The booth 1B according to the present exemplary embodiment differs from the booth 1 according to the first exemplary embodiment and the booth 1A according to the second exemplary embodiment in that the image forming apparatus 100C accommodated therein includes plural mail boxes 160 in which printed paper sheets P are stacked. Components that are the same as those in the booth 1 according to the first exemplary embodiment and the booth 1A according to the second exemplary embodiment are denoted by the same reference signs, and detailed description thereof is omitted.

As illustrated in FIG. 17B, the image forming apparatus 100C includes the mail boxes 160, in which the printed paper sheets P are stacked, in the internal space ST that is above the image forming unit 110 and below the image reading device 130.

As illustrated in FIG. 18, the mail boxes 160 include a first bin 161 that is accessible from inside the booth 1B and a second bin 162 that is accessible from outside the booth 1B.

The user in the booth 1B operates the subscriber terminal SP with which the use of the booth 1B has been reserved, places the subscriber terminal SP in a certain position, or reads a two-dimensional code pattern, which is an example of a code displayed on the booth 1B. Accordingly, the first opening 30 is uncovered and the first bin 161 is unlocked to enable the paper sheets P that have been printed on and stacked in the first bin 161 to be taken out (see arrow R4 in FIGS. 17A, 17B, and 18).

The user outside the booth 1B operates the subscriber terminal SP with which the use of the image forming apparatus 100C has been reserved, so that the second opening 40 is uncovered and the second bin 162 is unlocked to enable the paper sheets P that have been printed on and stacked in the second bin 162 to be taken out (see arrow R5 in FIGS. 17A and 18).

Thus, the mail boxes 160 in which the printed paper sheets P are stacked are provided. The mail boxes 160 may be unlocked to enable access thereto by operating the subscriber terminal SP with which the use of the booth 1B has been reserved or the subscriber terminal SP with which the use of the image forming apparatus 100C has been reserved. Therefore, printed objects that have been printed independently from inside and outside the booth may be prevented from being stolen.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A booth that is available for use when reserved and that is installed with an image forming apparatus accommodated therein, the booth comprising:
a panel having a first opening through which the image forming apparatus accommodated in the booth is operable by a person who has entered the booth; and
a panel having a second opening through which the image forming apparatus accommodated in the booth is operable by a person from outside the booth.

2. The booth according to claim 1, wherein the first opening has a first door that blocks access to the image forming apparatus, and
wherein if a user reserves use of the image forming apparatus upon reservation for use of the booth, the first door moves to a position for enabling access to the image forming apparatus when the user enters the booth.

3. The booth according to claim 2, wherein when the first door is opened to enable operation of the image forming apparatus, the image forming apparatus is capable of being pulled out into an inner space in the booth.

4. The booth according to claim 2, wherein the first door does not open when the image forming apparatus is being operated by a person through the second opening.

5. The booth according to claim 1, wherein the second opening has a second door that blocks access to the image forming apparatus and that has a lock unit capable of being unlocked with a key opening signal, the lock unit being unlocked to enable access to the image forming apparatus when a user of the image forming apparatus operates a terminal with which use of the image forming apparatus has been reserved.

6. The booth according to claim 5, wherein when the second door is opened to enable operation of the image forming apparatus, the image forming apparatus is capable of being pulled out of the booth.

7. The booth according to claim 5, wherein the second door does not open when the image forming apparatus is being operated by a person through the first opening.

8. The booth according to claim 1, wherein the second opening has a third door that is openable and closable and that is opened to enable access to a paper storage unit of the image forming apparatus.

9. The booth according to claim 1, wherein the image forming apparatus includes a first paper output tray from which a paper sheet is taken out in a direction toward the first opening, and a second paper output tray from which a paper sheet is taken out in a direction toward the second opening.

10. The booth according to claim 1, wherein the image forming apparatus includes an image reading device to which a document is inserted in a direction from the first opening and on which a document is placed in a direction from the second opening.

11. The booth according to claim 1, wherein the image forming apparatus includes a first operation display unit that receives an operation instruction from a person through the first opening and that displays a screen, and a second operation display unit that receives an operation instruction from a person through the second opening and that displays a screen.

12. The booth according to claim 1, wherein the image forming apparatus includes a plurality of mail boxes in which printed paper sheets are stacked, each of the mail boxes being unlocked to enable access thereto when a terminal with which use of the booth has been reserved or a terminal with which use of the image forming apparatus has been reserved is operated.

13. The booth according to claim 1, wherein the image forming apparatus includes a first image forming apparatus accessible in a direction from the first opening and a second image forming apparatus accessible in a direction from the second opening.

14. The booth according to claim 1, wherein no fee is charged when printing is not performed by the image forming apparatus due to lack of paper.

15. The booth according to claim 1, wherein when printing is not performed by the image forming apparatus due to lack of paper, the image forming apparatus transfers a print job to an image forming apparatus in another booth and displays a location of the other booth.

16. The booth according to claim 1, wherein the image forming apparatus is disposed in a space provided with a covering member that blocks entrance of one or more of air discharged from an air conditioner disposed in the booth, air sucked into the air conditioner, and water vapor from the air conditioner.

17. The booth according to claim 16, wherein a passage of an air flow generated by the air conditioner is disposed in a region such that the air flow does not interfere with a body portion of the image forming apparatus.

18. The booth according to claim 1, wherein a height of an installation surface on which the image forming apparatus is installed is adjustable.

19. The booth according to claim 1, wherein the booth is processed to reduce visibility of the image forming apparatus from locations outside the booth other than a location in front of the second opening.

20. The booth according to claim 19, wherein guide information indicating presence of the image forming apparatus is displayed in a region around the location in front of the second opening.
